(19) United States
(12) Patent Application Publication
(10) Pub. No.: US 2018/0236569 A1
(43) Pub. Date: Aug. 23, 2018

(54) METHOD FOR PRODUCING DIFFERENTLY SHAPED POLARIZING PLATE

(71) Applicant: Sharp Kabushiki Kaisha, Sakai City, Osaka (JP)

(72) Inventors: Yasuhiko SUGIHARA, Sakai City (JP); Saori KUROGANE, Sakai City (JP); Takeyuki ASHIDA, Sakai City (JP)

(21) Appl. No.: 15/759,231

(22) PCT Filed: Sep. 9, 2016
(86) PCT No.: PCT/JP2016/076553

§ 371 Date: Mar. 12, 2018

(30) Foreign Application Priority Data
Sep. 16, 2015 (JP) 2015-183036

(51) Int. Cl. B23C 3/13; G02B 5/30

(52) U.S. Cl. CPC B23C 3/13; G02B 5/3025

(57) ABSTRACT

The present invention provides a method for producing a differently shaped polarizing plate, the method being capable of preventing a decrease in durability. The method for producing a differently shaped polarizing plate of the present invention includes a step of forming a differently shaped portion by moving at least one of a rectangular polarizing plate and an end mill blade while the end mill blade is rotated and pressed against the rectangular polarizing plate to cut the rectangular polarizing plate. Preferably, the step is performed while a jig is pressed against the rectangular polarizing plate, at the periphery of a region to be cut.

### TECHNICAL FIELD

The present invention relates to a method for producing a differently shaped polarizing plate. More specifically, the present invention relates to a method for producing a polarizing plate having a shape different from a rectangle.

### BACKGROUND ART

Polarizing plates are known for their use in combination with display panels (e.g., liquid crystal display panels) in display devices (e.g., liquid crystal display devices) that emit polarized light. Polarizing plates are usually cut out from a roll of raw sheet into rectangles according to the screen size of display panels. A common method for cutting polarizing plates is a method that employs a punching die (hereinafter also referred to as the “punching method”) (for example, see Patent Literature 1).

### CITATION LIST

### Patent Literature

Patent Literature 1: JP 2007-187781 A

### SUMMARY OF INVENTION

### Technical Problem

Lately, as display devices have been used in various applications, there has been an increasing demand for display devices having a shape different (hereinafter also referred to as “differently shaped”) from conventional rectangles. In this regard, in order to provide desired, differently shaped display devices, for example, methods for producing a differently shaped polarizing plate by forming a hole in a rectangular polarizing plate have been studied. However, the present inventors found, as a result of their studies, that when such a hole is formed by the punching method, a durability test (heat shock test) causes cracks in the differently shaped polarizing plate. As a result of extensive studies on causes, the present inventors found that such cracks occur as described below.

The formation of a hole in the rectangular polarizing plate by the punching method is described with reference to FIG. 21. FIG. 21 shows schematic cross-sectional views that illustrate a method for producing a differently shaped polarizing plate by the punching method (steps a to c).

### (a) Initial Arrangement

First, as shown in FIG. 21(a), a buffer 104 is placed on a stage 103, and further, a rectangular polarizing plate 101a (hereinafter also simply referred to as the “polarizing plate 101a”) is placed on the buffer 104. In addition, a punching die 107 is placed above the polarizing plate 101a (on the side opposite to the stage 103). The punching die 107 is, for example, a Thomson punching die with a Thomson blade, a pinnacle punching die with a pinnacle blade, or an engraving die with an engraving blade.

### (b) Punching of Rectangular Polarizing Plate

As shown in FIG. 21(b), the punching die 107 is lowered toward the stage 103 (the buffer 104) to punch the polarizing plate 101a.

### (c) Completion of Differently Shaped Polarizing Plate

As shown in FIG. 21(c), the punching die 107 is raised. As a result, a differently shaped polarizing plate 101b (hereinafter also simply referred to as the “polarizing plate 101b”) having a hole 105 formed within a face of the polarizing plate 101a is obtained.

Here, in step (b), a large shock (stress) is applied to an edge of a face to be punched (a peripheral surface of the hole 105) of the polarizing plate 101a. When a heat shock test to examine the durability is performed on the polarizing plate 101b, as shown in FIG. 22, a crack 108 occurs from the punched portion (the hole 105) due to stress caused by contraction of the polarizing plate 101b. FIG. 22 shows a schematic plan view of cracking in a differently shaped polarizing plate. For example, when the polarizing plate 101b as shown in FIG. 22 is attached to a liquid crystal display panel, light leaks from the crack 108, degrading the display quality.

Patent Literature 1 discloses a method for producing an optical film product by the punching method. Patent Literature 1, however, nowhere mentions the cracks and is not intended to prevent the occurrence thereof.

The present invention is made in view of the current situation described above, and aims to provide a method for producing a differently shaped polarizing plate, the method being capable of preventing a decrease in durability.

### Solution to Problem

After various studies on methods for producing a differently shaped polarizing plate which can prevent a decrease in durability, the present inventors focused on a method for changing a rectangular polarizing plate into a polarizing plate with a different shape while suppressing shock (stress) to the polarizing plate. Then, the present inventors found that when a method that employs an end mill blade (hereinafter also referred to as the “end mill method”) is used to cut a rectangular polarizing plate, it is possible to produce a polarizing plate with a different shape while suppressing damage to the rectangular polarizing plate, as compared to other methods such as the punching method. As a result, they found that no cracks occur in the differently shaped polarizing plate even when the heat shock test is performed. Thus, the present inventors arrived at an idea that can successfully solve the problems described above and completed the present invention.

Specifically, in one aspect, the present invention may provide a method for producing a differently shaped polarizing plate, the method including a step of forming a differently shaped portion by moving at least one of a rectangular polarizing plate and an end mill blade while the end mill blade is rotated and pressed against the rectangular polarizing plate to cut the rectangular polarizing plate.

### Advantageous Effects of Invention

The present invention can provide a method for producing a differently shaped polarizing plate, the method being capable of preventing a decrease in durability.

### BRIEF DESCRIPTION OF DRAWINGS

FIG. 1 shows schematic cross-sectional views that illustrates a method for producing a differently shaped polarizing plate of Embodiment 1 (steps a to c).

FIG. 2 shows a schematic plan view of the step shown in FIG. 1(b) as viewed from above.

FIG. 3 shows a schematic plan view of an exemplary shape of a hole formed within a face of a rectangular polarizing plate.

FIG. 4 shows a schematic plan view of another exemplary shape of a hole formed within a face of a rectangular polarizing plate, which is a different shape from the one in FIG. 3.

FIG. 5 shows schematic cross-sectional views that illustrate a method for producing a differently shaped polarizing plate of Embodiment 2 (steps a to c).

FIG. 6 shows a schematic plan view of the step shown in FIG. 5(b) as viewed from above.

FIG. 7 shows schematic cross-sectional views that illustrate a method for producing a differently shaped polarizing plate of Embodiment 3 (steps a to c).

FIG. 8 shows a schematic plan view of the step shown in FIG. 7(b) as viewed from above.

FIG. 9 shows schematic cross-sectional views that illustrate a method for producing a differently shaped polarizing plate of Embodiment 4 (steps a to c).

FIG. 10 shows a schematic plan view of the step shown in FIG. 9(b) as viewed from above.

FIG. 11 shows a schematic plan view of the step shown in FIG. 9(c) as viewed from above.

FIG. 12 shows schematic cross-sectional views that illustrate a method for producing a differently shaped polarizing plate of Embodiment 5 (steps a to d).

FIG. 13 shows a schematic plan view of the step shown in FIG. 12(b) as viewed from above.

FIG. 14 shows a schematic plan view of the step shown in FIG. 12(c) as viewed from above.

FIG. 15 shows a schematic plan view of the step shown in FIG. 12(d) as viewed from above.

FIG. 16 shows a schematic plan view of a differently shaped polarizing plate produced by a method for producing a differently shaped polarizing plate of Example 1.

FIG. 17 shows a schematic plan view of a differently shaped polarizing plate produced by a method for producing a differently shaped polarizing plate of Comparative Example 1.

FIG. 18 shows a schematic plan view of cracking in a differently shaped polarizing plate produced by a method for producing a differently shaped polarizing plate of Comparative Example 8.

FIG. 19 shows exemplary photos of a differently shaped polarizing plate produced by a punching method before a heat shock test. FIG. 19(a) shows a hole and its periphery, and FIG. 19(b) shows an enlarged view of a portion surrounded by dotted lines in FIG. 19(a).

FIG. 20 shows exemplary photos of a differently shaped polarizing plate produced by an end mill method before a heat shock test. FIG. 20(a) shows a hole and its periphery, and FIG. 20(b) shows an enlarged view of a portion surrounded by dotted lines in FIG. 20(a).

FIG. 21 shows schematic cross-sectional views that illustrate a method for producing a differently shaped polarizing plate by a punching method (steps a to c).

FIG. 22 shows a schematic plan view of cracking in a differently shaped polarizing plate.

### DESCRIPTION OF EMBODIMENTS

The present invention is described below in more detail with reference to the drawings in the following embodiments, but is not limited to these embodiments. In the following description, similar symbols are commonly used in different drawings for the same portions or portions with similar functions, and repetitive descriptions are appropriately omitted. In addition, features of the embodiments may be appropriately combined or modified without departing from the gist of the present invention.

As used herein, the “differently shaped” indicates a shape different from a rectangle. As used herein, the “differently shaped portion” indicates a portion that is formed by cutting a rectangular polarizing plate and that alters the shape of a rectangular polarizing plate into a differently shaped polarizing plate. The shape of the differently shaped portion is not particularly limited. For example, it may be a hole provided within a face of a rectangular polarizing plate, or a recessed portion or a projected portion provided at a peripheral portion of a rectangular polarizing plate. In order to sufficiently prevent the occurrence of cracks in the differently shaped polarizing plate, the differently shaped portion preferably has a profile with curved lines (without corners).

### Embodiment 1

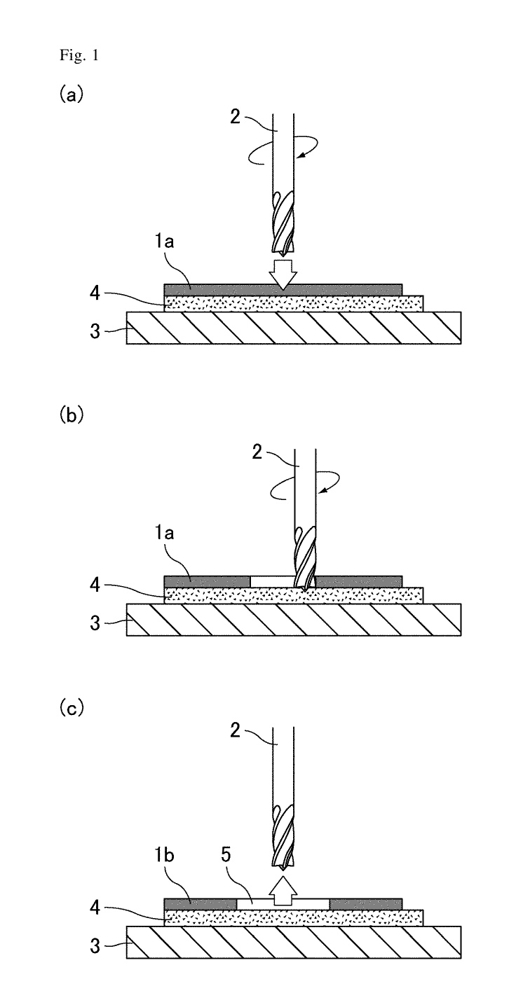

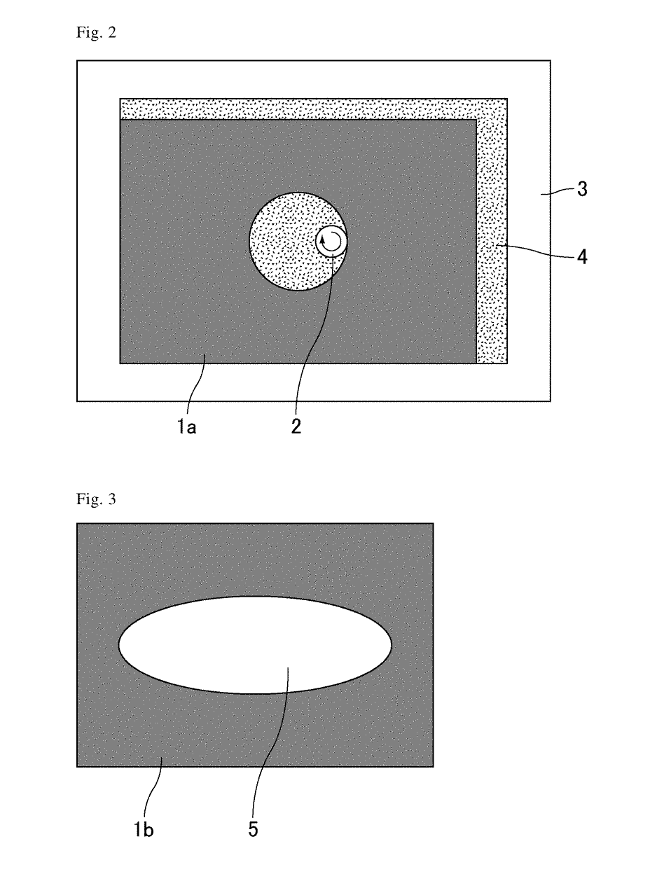

Embodiment 1 describes a case where a hole as the differently shaped portion is formed within a face of the rectangular polarizing plate. A method for producing a differently shaped polarizing plate of Embodiment 1 is described below with reference to FIG. 1 and FIG. 2. FIG. 1 shows schematic cross-sectional views that illustrate a method for producing a differently shaped polarizing plate of Embodiment 1 (steps a to c). FIG. 2 shows a schematic plan view of the step shown in FIG. 1(b) as viewed from above.

### (a) Initial Arrangement

First, as shown in FIG. 1(a), a buffer 4 is placed on a stage 3, and further, a rectangular polarizing plate 1a (hereinafter also simply referred to as the “polarizing plate 1a”) is placed on the buffer 4. In addition, an end mill blade 2 is placed above the polarizing plate 1a (on the side opposite to the stage 3).

### (b) Cutting of Rectangular Polarizing Plate

The end mill blade 2 is lowered toward the stage 3 (the buffer 4) while being rotated to preform a hole having the same diameter as the blade diameter of the end mill blade 2 within a face of the polarizing plate 1a. Subsequently, as shown in FIG. 1(b), at least one of the polarizing plate 1a and the end mill blade 2 is moved while the end mill blade 2 is rotated and pressed against the inner peripheral surface of the preformed hole. In this manner, as shown in FIG. 2, the polarizing plate la is cut with an outer blade of the end mill blade 2 until a hole of a desired size is formed. Cutting conditions (e.g., rotating speed and feeding speed) of the end mill blade 2 are not particularly limited, and are appropriately selected considering, for example, the material of the polarizing plate 1a, accuracy (e.g., surface roughness) required for the surface cut, and cutting time (tact time). For example, the cutting time can be reduced by increasing the feeding speed of the end mill blade 2. The cutting time can also be reduced by increasing the rotating speed of the end mill blade 2 because a higher rotating speed increases the cut amount per unit time.

### (c) Completion of Differently Shaped Polarizing Plate

As shown in FIG. 1(c), the end mill blade 2 is raised. As a result, a differently shaped polarizing plate 1b (hereinafter also simply referred to as the “polarizing plate 1b”) having a hole 5 formed within a face of the polarizing plate 1a is obtained.

According to the method for producing a differently shaped polarizing plate of Embodiment 1, the hole 5 can be formed within a face of the polarizing plate 1a with the end mill blade 2 while damage to the polarizing plate 1a is suppressed, so that the polarizing plate 1b having excellent durability can be produced.

Any known end mill blade can be used as the end mill blade 2. The material of the end mill blade 2 is not particularly limited and appropriately selected depending on the material of the polarizing plate 1a. The blade diameter of the end mill blade 2 is not particularly limited and appropriately selected depending on the desired size of the hole 5.

A hard metal material such as stainless steel may be used as a material of the stage 3. The stage 3 preferably includes a mechanism for fixing the polarizing plate 1a and the buffer 4. Examples of such a mechanism include an adsorption mechanism including multiple pores provided on the surface of the stage 3, and a fixing mechanism including a pin (positioning pin) provided on the stage 3. Alternatively, a tape having an adhesive layer may be used to attach the polarizing plate 1a and the buffer 4 to the stage 3.

The stage 3 may have a dent. In this case, the polarizing plate 1a is simply placed on the stage 3 without placing the buffer 4 in such a manner that a desired region where a hole is formed in the polarizing plate 1a overlaps the dent.

Polystyrene, for example, is used as a material of the buffer 4. The thickness of the buffer 4 is not particularly limited.

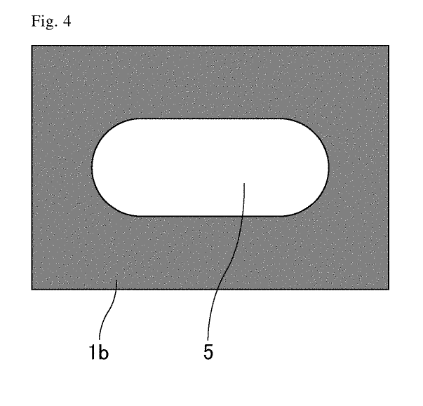

The shape of the hole 5 is not particularly limited and may be a shape other than the circle shown in FIG. 2. Examples of the shape other than the circle include those shown in FIG. 3 and FIG. 4. FIG. 3 shows a schematic plan view of an exemplary shape of a hole formed within a face of a rectangular polarizing plate. FIG. 4 shows a schematic plan view of another exemplary shape of a hole formed within a face of a rectangular polarizing plate, which is a different shape from the one in FIG. 3. As shown in FIG. 3, the hole 5 may have an ellipse shape. In addition, as shown in FIG. 4, the hole 5 may have a profile with straight lines and curved lines in combination. A polygonal shape may also be mentioned as another example of the shape. In order to sufficiently prevent the occurrence of cracks in the polarizing plate 1b, the shape of the hole 5 is preferably one having a profile with curved lines (without corners) such as a circle or an ellipse.

The size of the hole 5 is not particularly limited. For example, when the hole 5 is circular, the diameter of the hole 5 is not particularly limited. The number of the holes 5 is not particularly limited. The number may be one or two or more. In the case of forming multiple holes within a face of the polarizing plate 1a, the multiple holes may be formed simultaneously with multiple end mill blades. In this manner, the multiple holes can be efficiently formed.

### Embodiment 2

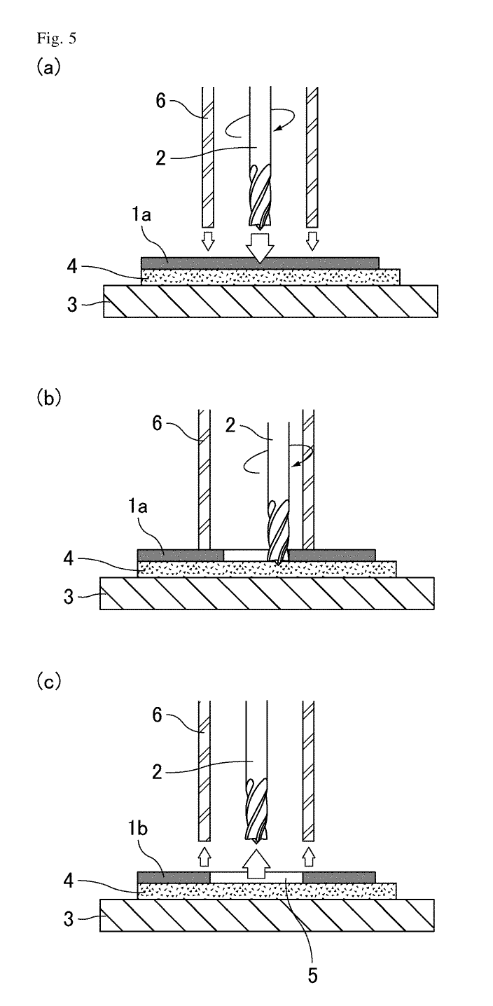

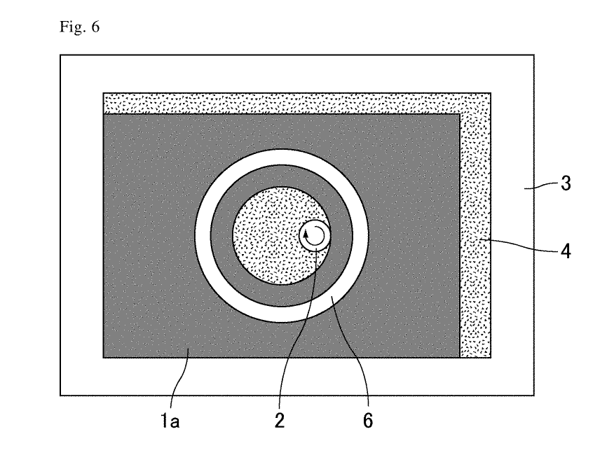

FIG. 5 shows schematic cross-sectional views that illustrate a method for producing a differently shaped polarizing plate of Embodiment 2 (steps a to c). FIG. 6 shows a schematic plan view of the step shown in FIG. 5(b) as viewed from above. Embodiment 2 is the same as Embodiment 1 except that a jig is pressed against the rectangular polarizing plate, at the periphery of a region to be cut. Thus, overlapping descriptions are appropriately omitted.

### (a) Initial Arrangement

First, as shown in FIG. 5(a), the buffer 4 is placed on the stage 3, and further, the polarizing plate 1a is placed on the buffer 4. In addition, the end mill blade 2 is placed above the polarizing plate 1a (on the side opposite to the stage 3). Further, a tubular jig 6 is placed to surround the end mill blade 2.

### (b) Cutting of Rectangular Polarizing Plate

The end mill blade 2 is lowered toward the stage 3 (the buffer 4) while being rotated to preform a hole having the same diameter as the blade diameter of the end mill blade 2 within a face of the polarizing plate 1a. Subsequently, as shown in FIG. 5(b), at least one of the polarizing plate 1a and the end mill blade 2 is moved while the end mill blade 2 is rotated and pressed against the inner peripheral surface of the preformed hole. In this manner, as shown in FIG. 6, the polarizing plate 1a is cut with an outer blade of the end mill blade 2 until a hole of a desired size is formed. Here, the polarizing plate 1a is cut while the jig 6 is pressed against the polarizing plate 1a, at the periphery of a region to be cut, as shown in FIG. 5(b) and FIG. 6.

### (c) Completion of Differently Shaped Polarizing Plate

As shown in FIG. 5(c), the end mill blade 2 and the jig 6 are raised. As a result, the polarizing plate 1b having the hole 5 formed within a face of the polarizing plate 1a is obtained.

According to the method for producing a differently shaped polarizing plate of Embodiment 2, the polarizing plate 1b having excellent durability can be obtained as in the method for producing a differently shaped polarizing plate of Embodiment 1. In some cases, the periphery of a region to be cut of the polarizing plate 1a may be lifted (on the side opposite to the stage 3) when cutting the polarizing plate 1a with the end mill blade 2. Consequently, the obtained polarizing plate 1b may be deformed with the periphery of the hole 5 being lifted. When attaching such a polarizing plate 1b to a display panel, the lifted portion of the polarizing plate 1b may hinder smooth attachment or air bubbles may enter the lifted portion of the polarizing plate 1b. In addition, the display quality may be degraded at the lifted portion of the polarizing plate 1b. In this regard, according to the method for producing a differently shaped polarizing plate of Embodiment 2, such lifting can be prevented because the jig 6 is pressed against the periphery of a region to be cut of the polarizing plate 1a.

The jig 6 may not be tubular but may be of any shape as long as it can be pressed against the periphery of a region to be cut of the polarizing plate 1a. The jig 6 may be operated by the same driving mechanism as the one for the end mill blade 2 or may be operated by an independent driving mechanism.

### Embodiment 3

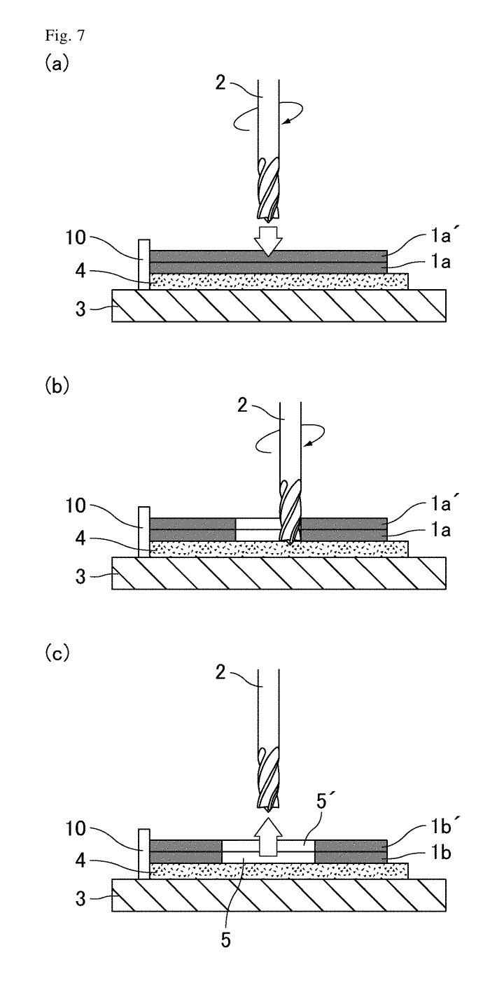

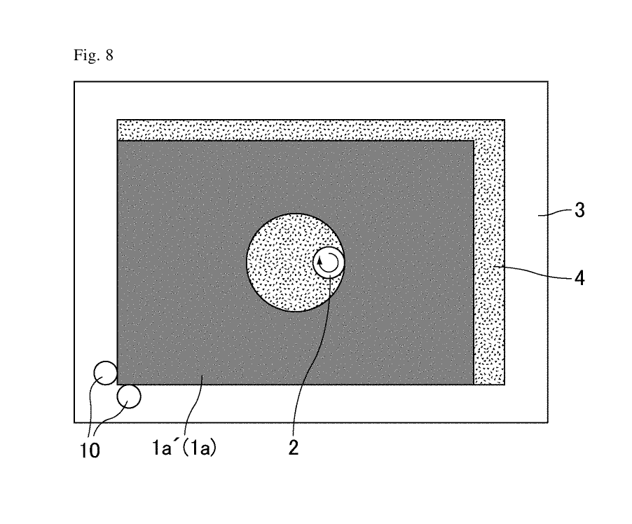

FIG. 7 shows schematic cross-sectional views that illustrate a method for producing a differently shaped polarizing plate of Embodiment 3 (steps a to c). FIG. 8 shows a schematic plan view of the step shown in FIG. 7(b) as viewed from above. Embodiment 3 is the same as Embodiment 1 except that cutting is performed on two rectangular polarizing plates in a stack. Thus, overlapping descriptions are appropriately omitted.

### (a) Initial Arrangement

First, as shown in FIG. 7(a), the buffer 4 is placed on the stage 3. Then, the polarizing plate 1a is placed on the buffer 4. Further, a rectangular polarizing plate 1a′ (hereinafter also simply referred to as the “polarizing plate 1a′”) is placed on the polarizing plate 1a. The polarizing plates 1a and 1a′ and the buffer 4 are positioned by pins 10. In addition, the end mill blade 2 is placed above the polarizing plate 1a′ (on the side opposite to the stage 3).

### (b) Cutting of Rectangular Polarizing Plate

The end mill blade 2 is lowered toward the stage 3 (the buffer 4) while being rotated to preform a hole having the same diameter as the blade diameter of the end mill blade 2 within faces of the polarizing plates 1a and 1a′. Subsequently, as shown in FIG. 7(b), at least one of a stack of the polarizing plates 1a and 1a′ and the end mill blade 2 is moved while the end mill blade 2 is rotated and pressed against the inner peripheral surface of the preformed hole. In this manner, as shown in FIG. 8, the polarizing plates 1a and 1a′ are cut with the outer blade of the end mill blade 2 until a hole of a desired size is formed.

### (c) Completion of Differently Shaped Polarizing Plate

As shown in FIG. 7(c), the end mill blade 2 is raised. As a result, the polarizing plate 1b having the hole 5 formed within a face of the polarizing plate 1a is obtained. Further, a differently shaped polarizing plate 1b′ (hereinafter also simply referred to as the “polarizing plate 1b′”) having the hole 5′ formed within a face of the polarizing plate 1a′ is obtained simultaneously.

According to the method for producing a differently shaped polarizing plate of Embodiment 3, the polarizing plates 1b and 1b′ having excellent durability can be produced simultaneously. Thus, according to the method for producing a differently shaped polarizing plate of Embodiment 3, the number of steps can be reduced compared to the method in which holes are sequentially formed in the rectangular polarizing plates one by one, so that multiple differently shaped polarizing plates can be efficiently produced. In addition, a decrease in the number of steps may bring a reduction in process cost and an improvement in yield.

In Embodiment 3, two rectangular polarizing plates in the stack are cut. Yet, cutting may be performed on three or more plates in a stack. In this case, the differently shaped polarizing plates can be more efficiently produced.

### Embodiment 4

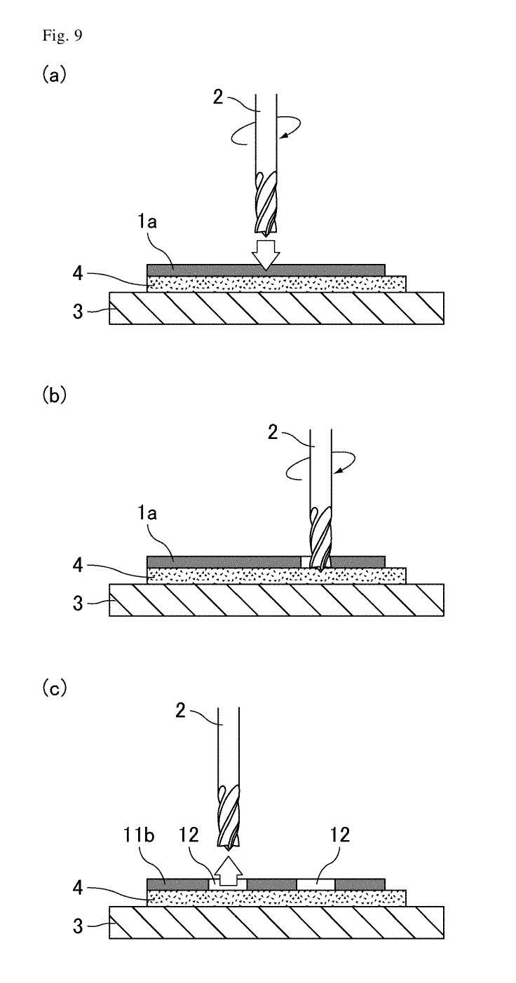

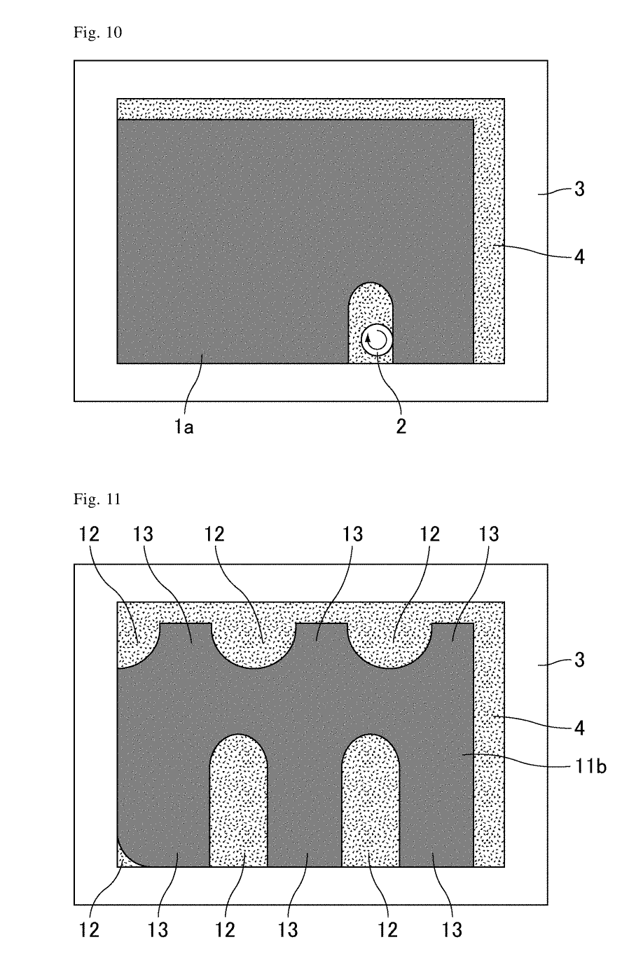

FIG. 9 shows schematic cross-sectional views that illustrate a method for producing a differently shaped polarizing plate of Embodiment 4 (steps a to c). FIG. 10 shows a schematic plan view of the step shown in FIG. 9(b) as viewed from above. FIG. 11 shows a schematic plan view of the step shown in FIG. 9(c) as viewed from above. Embodiment 4 is the same as Embodiment 1 except that recessed portions as differently shaped portions are formed at a peripheral portion of the rectangular polarizing plate. Thus, overlapping descriptions are appropriately omitted.

### (a) Initial Arrangement

First, as shown in FIG. 9(a), the buffer 4 is placed on the stage 3, and further, the polarizing plate 1a is placed on the buffer 4. In addition, the end mill blade 2 is placed above the polarizing plate 1a (on the side opposite to the stage 3).

### (b) Cutting of Rectangular Polarizing Plate

The end mill blade 2 is lowered toward the stage 3 (the buffer 4) while being rotated to preform a hole having the same diameter as the blade diameter of the end mill blade 2 within a face of the polarizing plate 1a. Subsequently, as shown in FIG. 9(b), at least one of the polarizing plate 1a and the end mill blade 2 is moved while the end mill blade 2 is rotated and pressed against the inner peripheral surface of the preformed hole. In this manner, as shown in FIG. 10, the polarizing plate 1a is cut with an outer blade of the end mill blade 2 until a recessed portion of a desired size is formed. Subsequently, the method described above is repeated to sequentially form multiple recessed portions.

In step (b) described above, the rectangular polarizing plate may be cut by a method different from the method described above. Specifically, at least one of the polarizing plate 1a and the end mill blade 2 may be moved while the end mill blade 2 is rotated and pressed against the peripheral portion (edge face) of the polarizing plate 1a. In this manner, the peripheral portion of the polarizing plate 1a is cut with the outer blade of the end mill blade 2 to form recessed portions.

### (c) Completion of Differently Shaped Polarizing Plate

As shown in FIG. 9(c), the end mill blade 2 is raised. As a result, as shown in FIG. 11, a polarizing plate 11b having the multiple (six in FIG. 11) recessed portions 12 formed at the peripheral portion of the polarizing plate 1a is obtained.

According to the method for producing a differently shaped polarizing plate of Embodiment 4, the multiple recessed portions 12 can be formed at the peripheral portion of the polarizing plate 1a with the end mill blade 2 while damage to the polarizing plate 1a is suppressed, so that the polarizing plate 11b having excellent durability can be produced.

The shape of each recessed portion 12 is not particularly limited and may be one different from those shown in FIG. 11. The size of each recessed portion 12 is not particularly limited. For example, when the recessed portion 12 is semicircular, the diameter of the recessed portion 12 is not particularly limited. The number of the recessed portions 12 is not particularly limited. The number may be one or two or more. When forming multiple recessed portions at the peripheral portion of the polarizing plate 1a, multiple recessed portions may be formed simultaneously using multiple end mill blades. In this manner, multiple recessed portions can be efficiently produced.

As shown in FIG. 11, peripheral regions of the multiple recessed portions 12 remain as multiple projected portions 13. In other words, according to the method for producing a differently shaped polarizing plate of Embodiment 4, the multiple projected portions 13 as the differently shaped portions are formed at the peripheral portion of the polarizing plate 1a. The projected portions 13 may be cut to a degree that these projected portions 13 are not integrated with the recessed portions 12.

### Embodiment 5

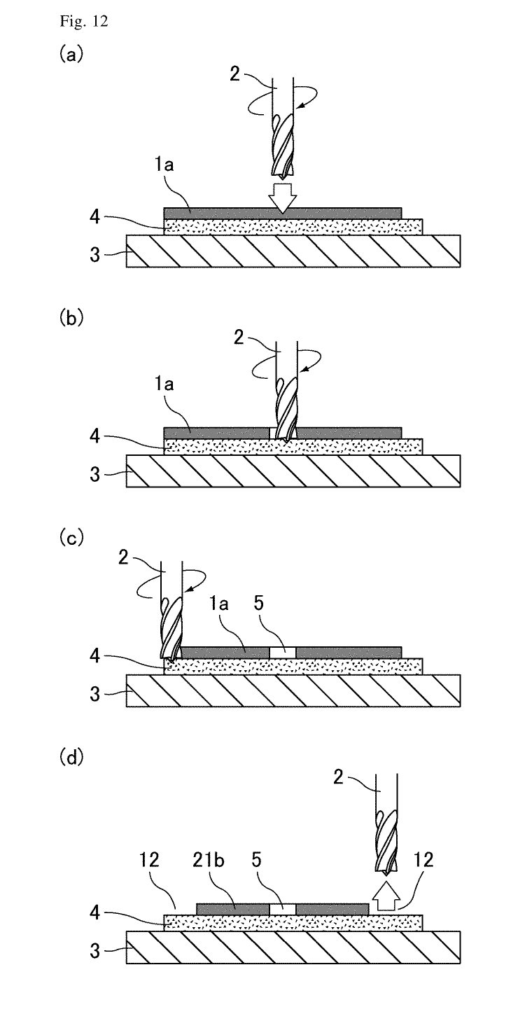

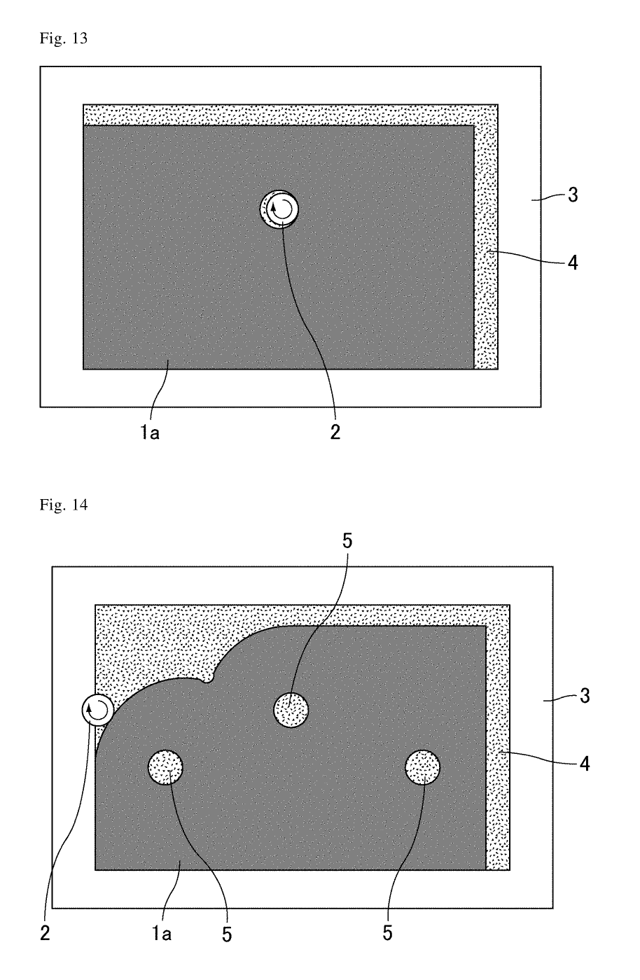

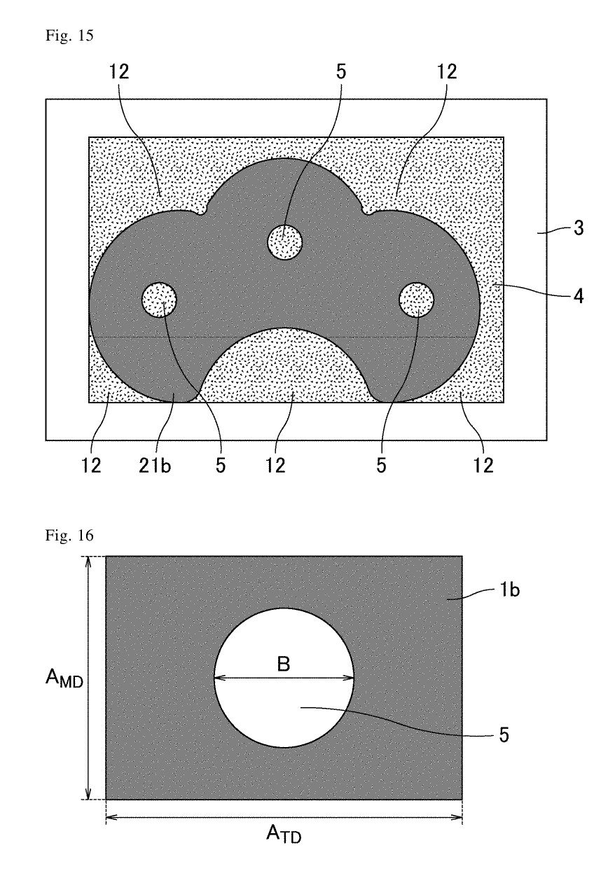

FIG. 12 shows schematic cross-sectional views that illustrate a method for producing a differently shaped polarizing plate of Embodiment 5 (steps a to d). FIG. 13 shows a schematic plan view of the step shown in FIG. 12(b) as viewed from above. FIG. 14 shows a schematic plan view of the step shown in FIG. 12(c) as viewed from above. FIG. 15 shows a schematic plan view of the step shown in FIG. 12(d) as viewed from above. Embodiment 5 is the same as Embodiment 1 except that holes as the differently shaped portions are formed within a face of the rectangular polarizing plate, and further, recessed portions as the differently shaped portions are formed at the peripheral portion of the rectangular polarizing plate. Thus, overlapping descriptions are appropriately omitted.

### (a) Initial Arrangement

First, as shown in FIG. 12(a), the buffer 4 is placed on the stage 3, and further, the polarizing plate 1a is placed on the buffer 4. In addition, the end mill blade 2 is placed above the polarizing plate 1a (on the side opposite to the stage 3).

### (b) Cutting of Rectangular Polarizing Plate (1)

The end mill blade 2 is lowered toward the stage 3 (the buffer 4) while being rotated to preform a hole having the same diameter as the blade diameter of the end mill blade 2 within a face of the polarizing plate 1a. Subsequently, as shown in FIG. 12(b), at least one of the polarizing plate 1a and the end mill blade 2 is moved while the end mill blade 2 is rotated and pressed against the inner peripheral surface of the preformed hole. In this manner, as shown in FIG. 13, the polarizing plate la is cut with an outer blade of the end mill blade 2 until a hole of a desired size is formed. Subsequently, the method described above is repeated to sequentially form multiple holes.

### (c) Cutting of Rectangular Polarizing Plate (2)

The end mill blade 2 is lowered toward the stage 3 (the buffer 4) while being rotated to preform a hole having the same diameter as the blade diameter of the end mill blade 2 within a face of the polarizing plate 1a. Subsequently, as shown in FIG. 12(c), at least one of the polarizing plate 1a and the end mill blade 2 is moved while the end mill blade 2 is rotated and pressed against the inner peripheral surface of the preformed hole. In this manner, as shown in FIG. 14, the polarizing plate la is cut with the outer blade of the end mill blade 2 until a recessed portion of a desired size is formed. Subsequently, the method described above is repeated to sequentially form multiple recessed portions.

### (d) Completion of Differently Shaped Polarizing Plate

As shown in FIG. 12(d), the end mill blade 2 is raised. As a result, as shown in FIG. 15, a polarizing plate 21b having the multiple (three in FIG. 15) holes 5 formed within a face of the polarizing plate 1a and having the multiple (five in FIG. 15) recessed portions 12 formed at the peripheral portion of the polarizing plate 1a is obtained.

According to the method for producing a differently shaped polarizing plate of Embodiment 5, the polarizing plate 21b having excellent durability can be produced.

The order of step (b) and step (c) described above may be switched. In other words, the steps may be performed in the order of steps (a), (c), (b), and (d). In addition, step (b) and step (c) may be performed simultaneously. In this case, the differently shaped polarizing plate can be more efficiently produced.

The present invention will be described below in more detail with reference to examples and comparative examples, but is not limited to these examples.

### EXAMPLE 1

A differently shaped polarizing plate was produced by the method for producing a differently shaped polarizing plate of Embodiment 1. The production process was as described below.

### (a) Initial Arrangement

First, the buffer 4 was placed on the stage 3, and further, the polarizing plate 1a was placed on the buffer 4. In addition, the end mill blade 2 was placed above the polarizing plate 1a (on the side opposite to the stage 3).

The polarizing plate 1a was a polarizing plate available from Nitto Denko Corporation (product name: CRT1794).

The end mill blade 2 was a super hard square end mill for resin machining available from Misumi Group Inc. (product name: SEC-PLEM2R). The end mill blade 2 had a blade diameter of 1.2 mm.

The stage 3 was a stainless steel stage.

The buffer 4 was a polystyrene buffer. The buffer 4 had a thickness of 0.48 mm.

### (b) Cutting of Rectangular Polarizing Plate

The end mill blade 2 was lowered toward the stage 3 (the buffer 4) while being rotated at a first rotating speed of 12000 rpm to preform a hole having the same diameter as the blade diameter of the end mill blade 2 within a face of the polarizing plate 1a. Subsequently, the end mill blade 2 was moved at a feeding speed of 0.5 mm/s while the end mill blade 2 was rotated at a second rotating speed of 12000 rpm and pressed against the inner peripheral surface of the preformed hole. In this manner, the polarizing plate 1a was cut with an outer blade of the end mill blade 2.

### (c) Completion of Differently Shaped Polarizing Plate

The end mill blade 2 was raised. As a result, as shown in FIG. 16, the polarizing plate 1b having the hole 5 formed within a face of the polarizing plate 1a was obtained. FIG. 16 shows a schematic plan view of the differently shaped polarizing plate produced by the method for producing a differently shaped polarizing plate of Example 1. The length Amp of the polarizing plate 1b in the machine direction (MD) was 50 mm. The length A_{TD} of the polarizing plate 1b in the transverse direction (TD) perpendicular to the machine direction was 30 mm. The machine direction is the direction in which the resin flows during the formation of the polarizing plate 1a. The hole 5 was circular with a diameter B of 2 mm.

### EXAMPLE 2

A differently shaped polarizing plate was produced by the same production method as in Example 1 except that the length A_{TD} of the polarizing plate 1b in the transverse direction was changed to 40 mm.

### EXAMPLE 3

A differently shaped polarizing plate was produced by the same production method as in Example 1 except that the length A_{TD} of the polarizing plate 1b in the transverse direction was changed to 50 mm.

### EXAMPLE 4

A differently shaped polarizing plate was produced by the same production method as in Example 1 except that the length A_{TD} of the polarizing plate 1b in the transverse direction was changed to 60 mm.

### EXAMPLE 5

A differently shaped polarizing plate was produced by the same production method as in Example 1 except that the length A_{TD} of the polarizing plate 1b in the transverse direction was changed to 70 mm.

### EXAMPLE 6

A differently shaped polarizing plate was produced by the same production method as in Example 1 except that the length A_{TD} of the polarizing plate 1b in the transverse direction was changed to 80 mm.

### EXAMPLE 7

A differently shaped polarizing plate was produced by the same production method as in Example 1 except that the length A_{TD} of the polarizing plate 1b in the transverse direction was changed to 90 mm.

### EXAMPLE 8

A differently shaped polarizing plate was produced by the same production method as in Example 1 except that the length A_{TD} of the polarizing plate 1b in the transverse direction was changed to 100 mm.

### EXAMPLE 9

A differently shaped polarizing plate was produced by the same production method as in Example 1 except that the length A_{TD} of the polarizing plate 1b in the transverse direction was changed to 125 mm.

### EXAMPLE 10

A differently shaped polarizing plate was produced by the same production method as in Example 1 except that the length A_{TD} of the polarizing plate 1b in the transverse direction was changed to 150 mm.

### EXAMPLE 11

A differently shaped polarizing plate was produced by the same production method as in Example 1 except that the length A_{TD} of the polarizing plate 1b in the transverse direction was changed to 175 mm.

### EXAMPLE 12

A differently shaped polarizing plate was produced by the same production method as in Example 1 except that the length A_{TD} of the polarizing plate 1b in the transverse direction was changed to 200 mm.

### EXAMPLE 13

A differently shaped polarizing plate was produced by the same production method as in Example 1 except that the conditions were changed as follows.

<Polarizing Plate 1b>
Length A_{TD} in the transverse direction: 200 mm

### <Hole 5>

Diameter B: 1 mm
   <End mill blade 2>
Blade diameter: 0.8 mm

### EXAMPLE 14

A differently shaped polarizing plate was produced by the same production method as in Example 1 except that the conditions were changed as follows.

<Polarizing Plate 1b>
Length A_{TD} in the transverse direction: 200 mm

### <Hole 5>

Diameter B: 4 mm

### <End Mill Blade 2>

Blade diameter: 3.0 mm

### EXAMPLE 15

A differently shaped polarizing plate was produced by the same production method as in Example 1 except that the conditions were changed as follows.

<Polarizing Plate 1b>
Length A_{TD} in the transverse direction: 200 mm

### <Hole 5>

Diameter B: 6 mm

### <End Mill Blade 2>

Blade diameter: 4.0 mm

### EXAMPLE 16

A differently shaped polarizing plate was produced by the same production method as in Example 1 except that the conditions were changed as follows.

<Polarizing Plate 1b>
Length A_{TD} in the transverse direction: 200 mm

### <Hole 5>

Diameter B: 8 mm

### <End Mill Blade 2>

Blade diameter: 6.0 mm

### COMPARATIVE EXAMPLE 1

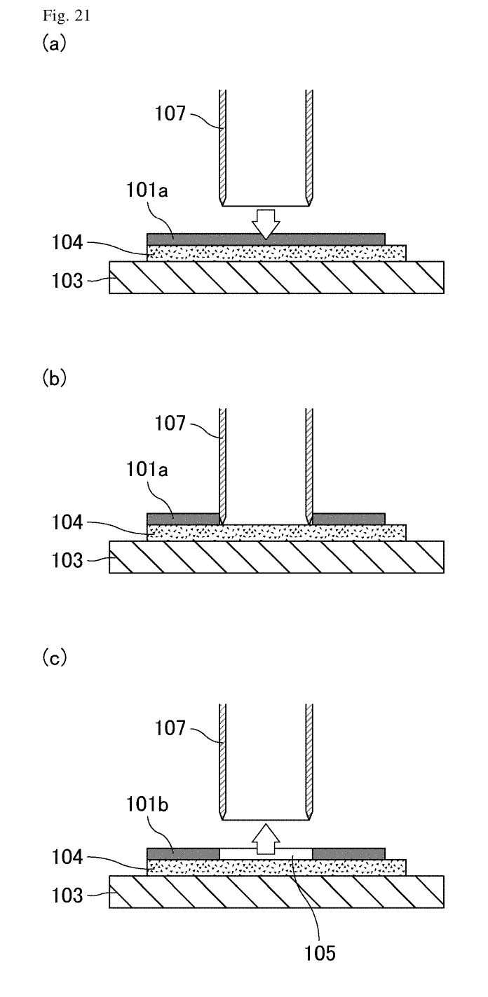

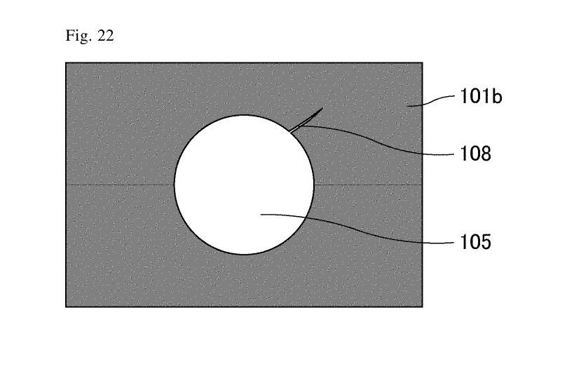

A differently shaped polarizing plate was produced by the punching method that has been described with reference to FIG. 21. The production process is as follows.

### (a) Initial Arrangement

First, the buffer 104 was placed on the stage 103, and further, the rectangular polarizing plate 101a was placed on the buffer 104. In addition, the punching die 107 was placed above the polarizing plate 101a (on the side opposite to the stage 103).

The polarizing plate 101a was a polarizing plate available from Nitto Denko Corporation (product name: CRT1794).

The punching die 107 was a pinnacle punching die.

The stage 103 was a stainless steel stage.

The buffer 104 was a polystyrene buffer. The buffer 104 had a thickness of 0.48 mm.

### (b) Punching of Rectangular Polarizing Plate

The punching die 107 was lowered toward the stage 103 (the buffer 104) to punch the polarizing plate 101a.

### (c) Completion of Differently Shaped Polarizing Plate

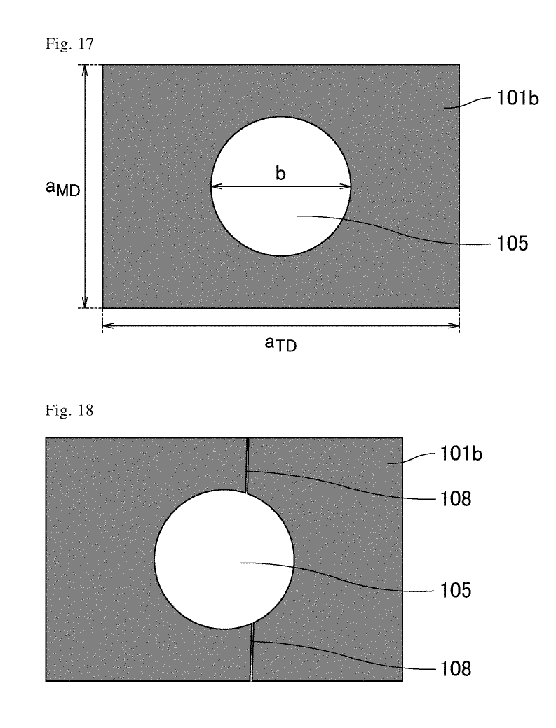

The punching die 107 was raised. As a result, as shown in FIG. 17, the polarizing plate 101b having the hole 105 formed within a face of the polarizing plate 101a was obtained. FIG. 17 shows a schematic plan view of a differently shaped polarizing plate produced by the method for producing a differently shaped polarizing plate of Comparative Example 1. The length amp of the polarizing plate 101b in the machine direction was 50 mm. The length a_{TD} of the polarizing plate 101b in the transverse direction perpendicular to the machine direction was 30 mm. The hole 105 was circular with a diameter b of 2 mm.

### COMPARATIVE EXAMPLE 2

A differently shaped polarizing plate was produced by the same production method as in Comparative Example 1 except that the length a_{TD} of the polarizing plate 101b in the transverse direction was changed to 40 mm.

### COMPARATIVE EXAMPLE 3

A differently shaped polarizing plate was produced by the same production method as in Comparative Example 1 except that the length a_{TD} of the polarizing plate 101b in the transverse direction was changed to 50 mm.

### COMPARATIVE EXAMPLE 4

A differently shaped polarizing plate was produced by the same production method as in Comparative Example 1 except that the length a_{TD} of the polarizing plate 101b in the transverse direction was changed to 60 mm.

### COMPARATIVE EXAMPLE 5

A differently shaped polarizing plate was produced by the same production method as in Comparative Example 1 except that the length a_{TD} of the polarizing plate 101b in the transverse direction was changed to 70 mm.

### COMPARATIVE EXAMPLE 6

A differently shaped polarizing plate was produced by the same production method as in Comparative Example 1 except that the length a_{TD} of the polarizing plate 101b in the transverse direction was changed to 80 mm.

### COMPARATIVE EXAMPLE 7

A differently shaped polarizing plate was produced by the same production method as in Comparative Example 1 except that the length a_{TD} of the polarizing plate 101b in the transverse direction was changed to 90 mm.

### COMPARATIVE EXAMPLE 8

A differently shaped polarizing plate was produced by the same production method as in Comparative Example 1 except that the length a_{TD} of the polarizing plate 101b in the transverse direction was changed to 100 mm.

### COMPARATIVE EXAMPLE 9

A differently shaped polarizing plate was produced by the same production method as in Comparative Example 1 except that the length a_{TD} of the polarizing plate 101b in the transverse direction was changed to 125 mm.

### COMPARATIVE EXAMPLE 10

A differently shaped polarizing plate was produced by the same production method as in Comparative Example 1 except that the length a_{TD} of the polarizing plate 101b in the transverse direction was changed to 150 mm.

### COMPARATIVE EXAMPLE 11

A differently shaped polarizing plate was produced by the same production method as in Comparative Example 1 except that the length a_{TD} of the polarizing plate 101b in the transverse direction was changed to 175 mm.

### COMPARATIVE EXAMPLE 12

A differently shaped polarizing plate was produced by the same production method as in Comparative Example 1 except that the length a_{TD} of the polarizing plate 101b in the transverse direction was changed to 200 mm.

### COMPARATIVE EXAMPLE 13

A differently shaped polarizing plate was produced by the same production method as in Comparative Example 1 except that the conditions were changed as follows.

<Polarizing Plate 101b>
Length a_{TD} in the transverse direction: 200 mm

### <Hole 105>

Diameter b: 1 mm

### COMPARATIVE EXAMPLE 14

A differently shaped polarizing plate was produced by the same production method as in Comparative Example 1 except that the conditions were changed as follows.

<Polarizing Plate 101b>
Length a_{TD} in the transverse direction: 200 mm

### <Hole 105>

Diameter b: 4 mm

### COMPARATIVE EXAMPLE 15

A differently shaped polarizing plate was produced by the same production method as in Comparative Example 1 except that the conditions were changed as follows.

<Polarizing Plate 101b>
Length a_{TD} in the transverse direction: 200 mm

### <Hole 105>

Diameter b: 6 mm

### COMPARATIVE EXAMPLE 16

A differently shaped polarizing plate was produced by the same production method as in Comparative Example 1 except that the conditions were changed as follows.

<Polarizing Plate 101b>
Length a_{TD} in the transverse direction: 200 mm

### <Hole 105>

Diameter b: 8 mm

### [Evaluation Test 1]

The differently shaped polarizing plates produced by the end mill method in Examples 1 to 16 and the punching method in Comparative Example 1 to 16 were each subjected to a heat shock test. Table 1 and Table 2 show the test results.

The heat shock test was performed using a thermal shock chamber available from Espec Corporation (product name: TSA-71L-A). Specifically, the differently shaped polarizing plate of each example was maintained in an environment at a temperature of 85° C. (hereinafter also referred to as the “environment E1”) for 30 minutes, and subsequently, was maintained in an environment at a temperature of −40° C. (hereinafter also referred to as the “environment E2”) for 30 minutes. This procedure as one cycle was repeated for 240 cycles. Here, the switching time between the environment E1 and the environment E2 was 30 minutes. After the heat shock test, the differently shaped polarizing plate of each example was visually observed for the occurrence of cracks. The results were shown with A indicating no occurrence of cracks and B indicating the occurrence of cracks.

TABLE 1

| | Heat shock test |
|---|---|
| | 240 cycles |
| Example 1 | A |
| Example 2 | A |
| Example 3 | A |
| Example 4 | A |
| Example 5 | A |
| Example 6 | A |
| Example 7 | A |
| Example 8 | A |
| Example 9 | A |
| Example 10 | A |
| Example 11 | A |
| Example 12 | A |
| Example 13 | A |
| Example 14 | A |
| Example 15 | A |
| Example 16 | A |

TABLE 2

| | Heat shock test |
|---|---|
| | 240 cycles |
| Comparative Example 1 | A |
| Comparative Example 2 | A |
| Comparative Example 3 | A |
| Comparative Example 4 | B |
| Comparative Example 5 | B |
| Comparative Example 6 | B |
| Comparative Example 7 | B |
| Comparative Example 8 | B |
| Comparative Example 9 | B |
| Comparative Example 10 | B |
| Comparative Example 11 | B |
| Comparative Example 12 | B |
| Comparative Example 13 | B |
| Comparative Example 14 | A |
| Comparative Example 15 | A |
| Comparative Example 16 | A |

As shown in Table 1, in Examples 1 to 16 (the end mill method), the heat shock test did not cause cracks in any case. In contrast, as shown in Table 2, in Comparative Examples 1 to 16 (the punching method), the heat shock test caused cracks in some cases (Comparative Examples 4 to 13). For example, in Comparative Example 8, the crack 108 shown in FIG. 18 occurred. FIG. 18 shows a schematic plan view of cracking in a differently shaped polarizing plate produced by the method for producing a differently shaped polarizing plate of Comparative Example 8. The crack 108 occurred in the machine direction (vertical direction in FIG. 18) of the polarizing plate 101b.

The above shows that the end mill method is better than the punching method in view of producing a differently shaped polarizing plate having excellent durability.

While the end mill method and the punching method were evaluated in Evaluation Test 1, a method that uses a laser (hereinafter also referred to as the “laser method”) may also be employed as another method. Specific examples of differently shaped polarizing plates produced by these three methods and the results of comparative evaluation are described below.

### EXAMPLE 17

A differently shaped polarizing plate was produced by the same production method as in Example 1 except that the conditions were changed as follows.

<Polarizing Plate 1b>
Length A_{TD} in the transverse direction: 70 mm

### <Hole 5>

Diameter B: 3 mm

### <End Mill Blade 2>

Blade diameter: 2.0 mm

### EXAMPLE 18

A differently shaped polarizing plate was produced by the same production method as in Example 17 except that the length A_{TD} of the polarizing plate 1b in the transverse direction was changed to 100 mm.

### EXAMPLE 19

A differently shaped polarizing plate was produced by the same production method as in Example 17 except that the length A_{TD} of the polarizing plate 1b in the transverse direction was changed to 120 mm.

### EXAMPLE 20

A differently shaped polarizing plate was produced by the same production method as in Example 17 except that the length A_{TD} of the polarizing plate 1b in the transverse direction was changed to 140 mm.

### EXAMPLE 21

A differently shaped polarizing plate was produced by the same production method as in Example 17 except that the length A_{TD} of the polarizing plate 1b in the transverse direction was changed to 160 mm.

### EXAMPLE 22

A differently shaped polarizing plate was produced by the same production method as in Example 17 except that the length A_{TD} of the polarizing plate 1b in the transverse direction was changed to 180 mm.

### EXAMPLE 23

A differently shaped polarizing plate was produced by the same production method as in Example 17 except that the length A_{TD} of the polarizing plate 1b in the transverse direction was changed to 200 mm.

### EXAMPLE 24

A differently shaped polarizing plate was produced by the same production method as in Example 17 except that the length A_{TD} of the polarizing plate 1b in the transverse direction was changed to 220 mm.

### COMPARATIVE EXAMPLE 17

A differently shaped polarizing plate was produced by the same production method as in Comparative Example 1 except that the diameter b of the hole 105 was changed to 3 mm.

### COMPARATIVE EXAMPLE 18

A differently shaped polarizing plate was produced by the same production method as in Comparative Example 17 except that the length a_{TD} of the polarizing plate 101b in the transverse direction was changed to 50 mm.

### COMPARATIVE EXAMPLE 19

A differently shaped polarizing plate was produced by the same production method as in Comparative Example 17 except that the length a_{TD} of the polarizing plate 101b in the transverse direction was changed to 70 mm.

### COMPARATIVE EXAMPLE 20

A differently shaped polarizing plate was produced by forming a hole in a rectangular polarizing plate by the laser method. Specifically, a hole was formed within a face of a polarizing plate available from Nitto Denko Corporation (product name: CRT1794) using a CO₂ laser processing available from Mitsuboshi Diamond Industrial Co., Ltd. The obtained differently shaped polarizing plate had the same schematic plan view as shown in FIG. 17. The length amp of the polarizing plate 101b in the machine direction was 50 mm. The length a_{TD} of the polarizing plate 101b in the transverse direction perpendicular to the machine direction was 70 mm. The hole 105 was circular with a diameter b of 3 mm.

### COMPARATIVE EXAMPLE 21

A differently shaped polarizing plate was produced by the same production method as in Comparative Example 20 except that the length a_{TD} of the polarizing plate 101b in the transverse direction was changed to 120 mm.

### COMPARATIVE EXAMPLE 22

A differently shaped polarizing plate was produced by the same production method as in Comparative Example 20 except that the length a_{TD} of the polarizing plate 101b in the transverse direction was changed to 220 mm.

### [Evaluation Test 2]

The differently shaped polarizing plates produced by the end mill method in Examples 17 to 24, the punching method in Comparative Examples 17 to 19, and the laser method in Comparative Examples 20 to 22 were each subjected to a heat shock test. Table 3, Table 4, and Table 5 show the test results.

The heat shock test was performed using a thermal shock chamber available from Espec Corporation (product name: TSA-71L-A). Specifically, the differently shaped polarizing plate of each example was maintained in an environment at a temperature of 85° C. (environment E1) for 30 minutes, and subsequently, was maintained in an environment at a temperature of −40° C. (environment E2) for 30 minutes. This procedure as one cycle was repeated for three sets of 120 cycles, 240 cycles, and 500 cycles per set. Here, the switching time between the environment E1 and the environment E2 was 30 minutes. After each set of the heat shock test, the differently shaped polarizing plate of each example was visually observed for the occurrence of cracks. The results were shown with A indicating no occurrence of cracks and B indicating the occurrence of cracks.

TABLE 3

| | Heat shock test | | |
|---|---|---|---|
| | 120 cycles | 240 cycles | 500 cycles |
| Example 17 | A | A | A |
| Example 18 | A | A | A |
| Example 19 | A | A | A |
| Example 20 | A | A | A |
| Example 21 | A | A | A |
| Example 22 | A | A | A |
| Example 23 | A | A | A |
| Example 24 | A | A | A |

TABLE 4

| | Heat shock test | | |
|---|---|---|---|
| | 120 cycles | 240 cycles | 500 cycles |
| Comparative Example 17 | A | A | B |
| Comparative Example 18 | A | A | B |
| Comparative Example 19 | A | B | B |

TABLE 5

| | Heat shock test | | |
|---|---|---|---|
| | 120 cycles | 240 cycles | 500 cycles |
| Comparative Example 20 | A | A | A |
| Comparative Example 21 | A | A | B |
| Comparative Example 22 | A | B | B |

As shown in Table 3, in Examples 17 to 24 (the end mill method), the heat shock test did not cause cracks in any case even when the heat shock test was repeated for 500 cycles. In contrast, as shown in Table 4, in Comparative Examples 17 to 19 (the punching method), the heat shock test caused cracks in every case during 500 cycles of the heat shock test. Also, as shown in Table 5, in Comparative Examples 20 to 22 (the laser method), the heat shock test caused cracks in some cases (Comparative Example 21 and Comparative Example 22) during 500 cycles of the heat shock test.

The above shows that the end mill method is the best and the punching method is the worst in view of producing a differently shaped polarizing plate having excellent durability. The laser method was able to produce differently shaped polarizing plates having better durability than those produced by the punching method, but the device for the laser method was more expensive than those for the end mill method and the punching method.

### [Examination of Cutting Conditions]

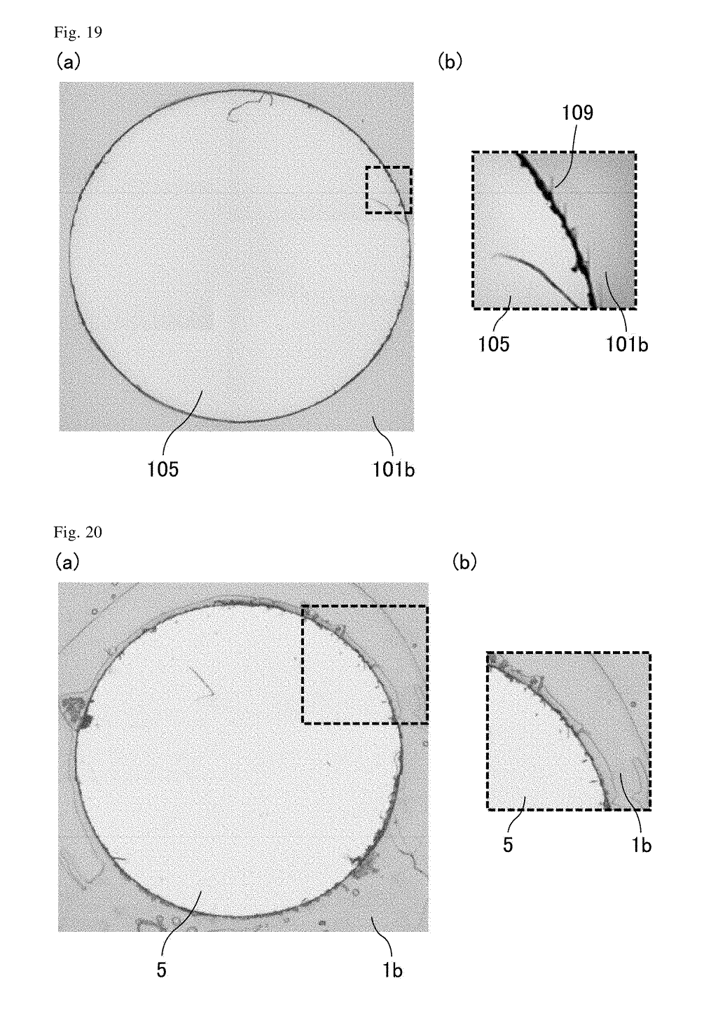

The above results of Evaluation Test 1 and Evaluation Test 2 indicate that the end mill method is better than the punching method in view of producing a differently shaped polarizing plate having excellent durability. The state of each of the differently shaped polarizing plates produced by the punching method and the end mill method before the heat shock test was observed with an optical microscope. FIG. 19 and FIG. 20 each show exemplary photos of the results of the observation. FIG. 19 shows exemplary photos of a differently shaped polarizing plate produced by the punching method before the heat shock test. FIG. 19(a) shows a hole and its periphery, and FIG. 19(b) shows an enlarged view of a portion surrounded by dotted lines in FIG. 19(a). FIG. 20 shows exemplary photos of a differently shaped polarizing plate produced by the end mill method before the heat shock test. FIG. 20(a) shows a hole and its periphery, and FIG. 20(b) shows an enlarged view of a portion surrounded by dotted lines in FIG. 20(a).

In the differently shaped polarizing plates produced by the punching method, as shown in FIG. 19(b), the occurrence of delamination 109 was observed at the peripheral portion of the hole 105 in the machine direction (vertical direction in FIG. 19) of the polarizing plate 101b.

In contrast, in the differently shaped polarizing plates produced by the end mill method, for example, as shown in FIG. 20(b), no delamination occurred at the peripheral portion of the hole 5. However, although it is not a problem level (not progressive level) in the heat shock test in the differently shaped polarizing plates produced by the end mill method, there were cases where delamination occurred depending on the cutting conditions. Thus, cutting conditions under which the end mill method is less likely to cause delamination were examined.

### STUDY EXAMPLES 1 to 9

Differently shaped polarizing plates were produced by the same production method as in Example 17 except that the cutting conditions as shown in Table 6 were employed. The differently shaped polarizing plates produced under the cutting conditions of the study examples were observed with an optical microscope for the occurrence of delamination. The results were shown in Table 6 with A indicating no occurrence of delamination and B indicating the occurrence of delamination.

TABLE 6

| | Cutting conditions | | | |
|---|---|---|---|---|
| | First | Second | | |
| | rotating | rotating | | |
| | speed | speed | Feeding speed | Occurrence of |
| | (rpm) | (rpm) | (mm/s) | delamiantion |
| Study Example 1 | 60000 | 60000 | 4 | A |
| Study Example 2 | 60000 | 60000 | 2 | A |
| Study Example 3 | 60000 | 60000 | 0.5 | B (seizure) |
| Study Example 4 | 30000 | 30000 | 4 | B |
| Study Example 5 | 30000 | 30000 | 2 | A |
| Study Example 6 | 30000 | 30000 | 0.5 | A |
| Study Example 7 | 12000 | 12000 | 4 | B |
| Study Example 8 | 12000 | 12000 | 2 | B |
| Study Example 9 | 12000 | 12000 | 0.5 | A |

As shown in Table 6, delamination did not occur in Study Examples 1, 2, 5, 6, and 9. Thus, if the cutting conditions of Study Examples 1, 2, 5, 6, and 9 are employed for forming the hole 5 in the polarizing plate 1a, it is possible to achieve a good state without delamination.

Here, a comparison of the study examples with the same feeding speed (e.g., Study Example 1, Study Example 4, and Study Example 7) shows that when the second rotating speed was higher, it resulted in an improved state where delamination was sufficiently prevented during the formation of the hole 5 in the polarizing plate 1a.

In addition, a comparison of the study examples with the same second rotating speed (e.g., Study Example 4, Study Example 5, and Study Example 6) shows that when the feeding speed was lower, it resulted in an improved state where delamination was sufficiently prevented during the formation of the hole 5 in the polarizing plate 1a. However, as is clear from a comparison of Study Example 1, Study Example 2, and Study Example 3, when the second rotating speed was very high (e.g., 60000 rpm), an excessively low feeding speed caused seizure on a face to be cut of the polarizing plate 1a (Study Example 3).

The above shows that it is possible, under optimal cutting conditions, to achieve an improved state where delamination is sufficiently prevented.

### [Additional Remarks]

Examples of preferred features of the method for producing a differently shaped polarizing plate of the present invention are listed below. These features may be appropriately combined without departing from the gist of the present invention.

The step may be performed while a jig is pressed against the rectangular polarizing plate, at the periphery of a region to be cut. Thus, in the step, the periphery of a region to be cut of the polarizing plate can be prevented from being lifted.

The step may be performed on the rectangular polarizing plate and at least one rectangular polarizing plate different from the rectangular polarizing plate in a stack. In this manner, multiple differently shaped polarizing plates can be efficiently produced.

The differently shaped portion may include a hole formed within a face of the rectangular polarizing plate. Thus, the present invention is also applicable when forming a hole as the differently shaped portion within a face of the rectangular polarizing plate.

The differently shaped portion may include a recessed portion formed at a peripheral portion of the rectangular polarizing plate. Thus, the present invention is also applicable when forming a recessed portion as the differently shaped portion at the peripheral portion of the rectangular polarizing plate.

The differently shaped portion may include a projected portion formed at a peripheral portion of the rectangular polarizing plate. Thus, the present invention is also applicable when forming a projected portion as the differently shaped portion at the peripheral portion of the rectangular polarizing plate.

### REFERENCE SIGNS LIST

1a, 1a′, 101a: rectangular polarizing plate
1b, 1b′, 11b, 21b, 101b: differently shaped polarizing plate
2: end mill blade
3, 103: stage
4, 104: buffer
5, 5′, 105: hole
6: jig
10: pin
12: recessed portion
13: projected portion
107: punching die
108: crack
109: delamination
A_{MD}, a_{MD}: length of differently shaped polarizing plate in machine direction (MD)
A_{TD}, a_{TD}: length of differently shaped polarizing plate in transverse direction (TD)
B, b: diameter of hole

1. A method for producing a differently shaped polarizing plate, the method comprising:
a step of forming a differently shaped portion by moving at least one of a rectangular polarizing plate and an end mill blade while the end mill blade is rotated and pressed against the rectangular polarizing plate to cut the rectangular polarizing plate.

2. The method for producing a differently shaped polarizing plate according to claim 1,
wherein the step is performed while a jig is pressed against the rectangular polarizing plate, at the periphery of a region to be cut.

3. The method for producing a differently shaped polarizing plate according to claim 1,
wherein the step is performed on the rectangular polarizing plate and at least one rectangular polarizing plate different from the rectangular polarizing plate in a stack.

4. The method for producing a differently shaped polarizing plate according to claim 1,
wherein the differently shaped portion includes a hole formed within a face of the rectangular polarizing plate.

5. The method for producing a differently shaped polarizing plate according to claim 1,
wherein the differently shaped portion includes a recessed portion formed at a peripheral portion of the rectangular polarizing plate.

6. The method for producing a differently shaped polarizing plate according to claim 1,
wherein the differently shaped portion includes a projected portion formed at a peripheral portion of the rectangular polarizing plate.
